(19) United States
(12) Patent Application Publication
(10) Pub. No.: US 2015/0367899 A1
(43) Pub. Date: Dec. 24, 2015

(54) MOUNTING SYSTEM FOR CAB

(71) Applicant: Caterpillar SARL, Geneva (CH)

(72) Inventors: Scott A. Christianson, Edelstein, IL (US); Brian R. Janes, Chillicothe, IL (US)

(21) Appl. No.: 14/307,647

(22) Filed: Jun. 18, 2014

(51) Int. Cl. B62D 33/07; E02F 9/16

(52) U.S. Cl. CPC B62D 33/071; E02F 9/166

(57) ABSTRACT

A cab frame mounting system is disclosed. The cab frame mounting system includes a cab mount to couple to a cab. The cab frame mounting system also includes a frame mount to couple to a frame. The method further includes a pin to couple the cab mount and the frame mount to define a pin axis. The cab mount includes a bracket. The bracket has an upright member with an opening formed therein to receive the pin and an angled portion coupled to the upright member. The frame mount includes a mounting head. The mounting head includes a base structure and a protruding head member. The protruding head member includes an opening formed therein to receive the pin. Further, each of the upright member and the protruding head member include angled surfaces. The angled portion and the mounting head each have an opening formed therein to receive a restriction element.

### TECHNICAL FIELD

The present disclosure relates to a mounting system, and more particularly, to the mounting system for mounting a cab on a machine.

### BACKGROUND

Construction machines, for example, trucks, include an operator cab. The cab may have an operator interface therein to allow an operator seated within the cab to maneuver the machine and/or perform an operation using a work implement of the machine.

During maintenance, the cab may need to be removed or tilted in order to access components present below the cab. Accordingly, in some machines, the cabs are pivotally mounted to a frame of the machine, via a mount structure. However, the design of the mount structure is such that during machine operation, the cab may experience fore and aft movements about the pivot connection to the frame of the machine. This may affect an overall experience of the operator, impacting the operator ride and perception. Hence, there is a need to provide an improved mount structure for the cab.

U.S. Application Publication Number 2006/071499 describes a load support apparatus of a driving room for a construction equipment in which a fitting boss is previously provided at the base of a vehicle frame to simply fix and detach the vehicle frame without disassembling the driving room in case that the vehicle frame has a closed structure, and the regulation member screwed onto the fitting boss is fixed to a bottom plate from the bottom frame of the driving room. The load support apparatus includes the vehicle frame provided in a lower carriage, the driving room loaded in the vehicle frame, having the bottom frame at the lower portion, a vibration damper provided between the vehicle frame and the bottom frame, elastically supporting the driving room, and a regulation member fixed to the vehicle frame from the bottom frame of the driving room even after assembly of the driving room is finished.

### SUMMARY OF THE DISCLOSURE

In one aspect of the present disclosure, a cab frame mounting system is disclosed. The cab frame mounting system includes a cab mount to couple to a cab. The cab frame mounting system also includes a frame mount to couple to a frame. The method further includes a pin to couple the cab mount and the frame mount. The pin defines a pin axis. The cab mount includes a bracket to be extended from a cab bottom. The bracket has an upright member with an opening formed therein to receive the pin and an angled portion coupled to the upright member. The frame mount includes a mounting head. The mounting head includes a base structure and a protruding head member. The protruding head member extends from the base structure and includes an opening formed therein to receive the pin. Further, each of the upright member and the protruding head member include angled surfaces that are in coplanar relationship to engage the angled portion of the bracket when the cab and frame mounts are coupled to one another. The angled surfaces extend obliquely relative to the cab bottom. Also, the angled portion and the mounting head each have an opening formed therein to receive a restriction element.

In another aspect of the present disclosure, a cab frame mounting system is disclosed. The cab frame mounting system includes a cab mount to couple to a cab. The cab frame mounting system also includes a frame mount to couple to a frame. The cab frame mounting system further includes a pin to couple the cab mount and the frame mount. The pin defines a pin axis. The cab mount includes a bracket to be extended from a cab bottom. The bracket has an upright member with an opening formed therein to receive the pin. The frame mount includes a mounting head. The mounting head include a base structure. The mounting head also includes a protruding head member extending from the base structure. The protruding head member includes an opening formed therein to receive the pin. Further, the bracket and the mounting head each have an opening formed therein to receive a restriction element. The restriction element defines an element axis. The element axis extends in spaced relationship from the pin axis.

In yet another aspect of the present disclosure, a machine is disclosed. The machine includes a frame. The machine also includes a cab. The machine further includes a cab frame mounting system to releasably couple the cab to the frame. The cab frame mounting system includes a cab mount coupled to a cab. The cab frame mounting system also includes a frame mount coupled to a frame. The machine further includes a pin to couple the cab mount and the frame mount. The pin defines a pin axis. The cab mount includes a bracket extending from a cab bottom. The bracket has an upright member with an opening formed therein to receive the pin and an angled portion coupled to the upright member. The frame mount includes a mounting head. The mounting head includes a base structure. The mounting head also includes a protruding head member extending from the base structure. The protruding head member includes an opening formed therein to receive the pin. Further, each of the upright member and the protruding head member include angled surfaces that are in coplanar relationship to engage the angled portion of the bracket when the cab and frame mounts are coupled to one another. The angled surfaces extend obliquely relative to the cab bottom. Also, the angled portion and the mounting head each have an opening formed therein to receive a restriction element.

Other features and aspects of this disclosure will be apparent from the following description and the accompanying drawings.

### BRIEF DESCRIPTION OF THE DRAWINGS

FIG. 1 is a perspective view of an exemplary machine, according to one embodiment of the present disclosure;

FIG. 2 is perspective view of a cab of the machine of FIG. 1, and a mounting system for the cab, according to one embodiment of the present disclosure;

FIG. 3 is a cross sectional view of the mounting system of FIG. 2;

FIG. 4 is a perspective view of another embodiment of the mounting system; and

FIGS. 5 and 6 are cross sectional views of the mounting system of FIG. 4, according to various embodiments of the present disclosure.

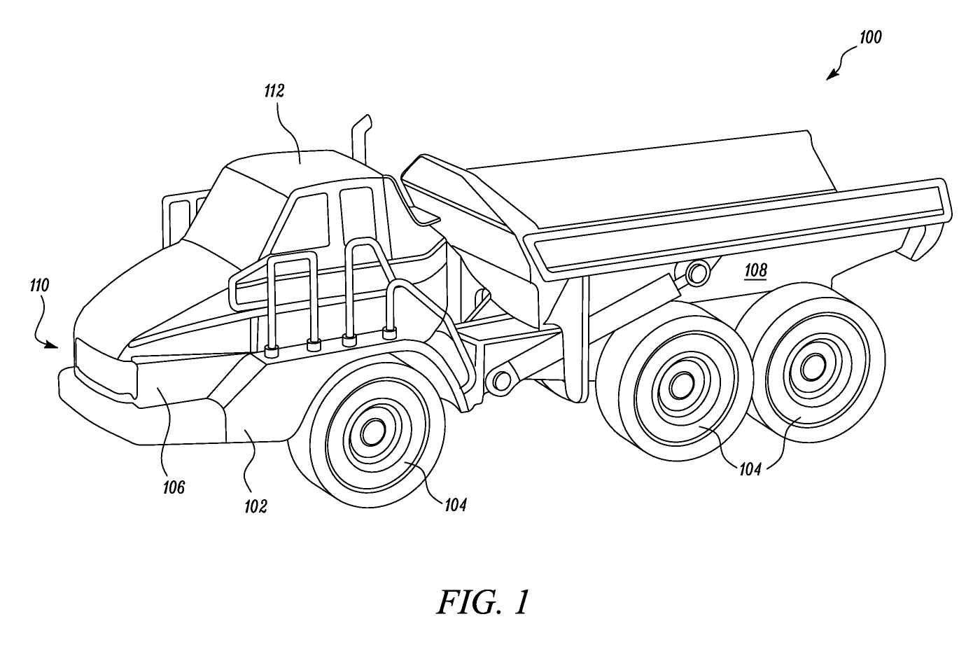

### DETAILED DESCRIPTION

Wherever possible, the same reference numbers will be used throughout the drawings to refer to the same or the like parts. FIG. 1 illustrates an exemplary machine 100. In one embodiment, the machine 100 may embody an articulated truck. Alternatively, the machine 100 may include a track-type tractor, a hydraulic excavator, a wheel loader, a haul truck, a large mining truck, an off-highway truck, and the like. It should be understood that the machine 100 may embody any wheeled or tracked machine associated with mining, agriculture, forestry, construction, and other industrial applications.

As illustrated in FIG. 1, the machine 100 may be a wheeled machine and includes a frame 102, wheels 104, an engine compartment 106, and a payload carrier 108. The machine 100 may further include an engine positioned in the engine compartment 106 and supported on the frame 102. The engine may be an internal combustion engine such as, for example, a reciprocating piston engine or a gas turbine engine. According to one embodiment of the present disclosure, the engine is a spark ignition engine or a compression ignition engine such as, a diesel engine, a homogeneous charge compression ignition engine, or a reactivity controlled compression ignition engine, or other compression ignition engine known in the art. The engine may be fueled by gasoline, diesel, biodiesel, dimethyl ether, alcohol, natural gas, propane, hydrogen, combinations thereof, or any other combustion fuel known in the art.

In the illustrated embodiment, a cab 112 is mounted on a front end 110 of the frame 102 of the machine 100. The cab 112 is disposed above the engine and extends rearward beyond the engine. In some embodiments, the cab 112 may enclose the engine by forming a portion of the engine compartment 106. The cab 112 may include a suitable station for a machine operator, and may house various controls, displays, and interface equipment for machine operation. In addition, the cab 112 may be structured in such a way as to provide roll-over protection for the machine operator, and also to mitigate potential damage to the machine operator in the event of roll-over.

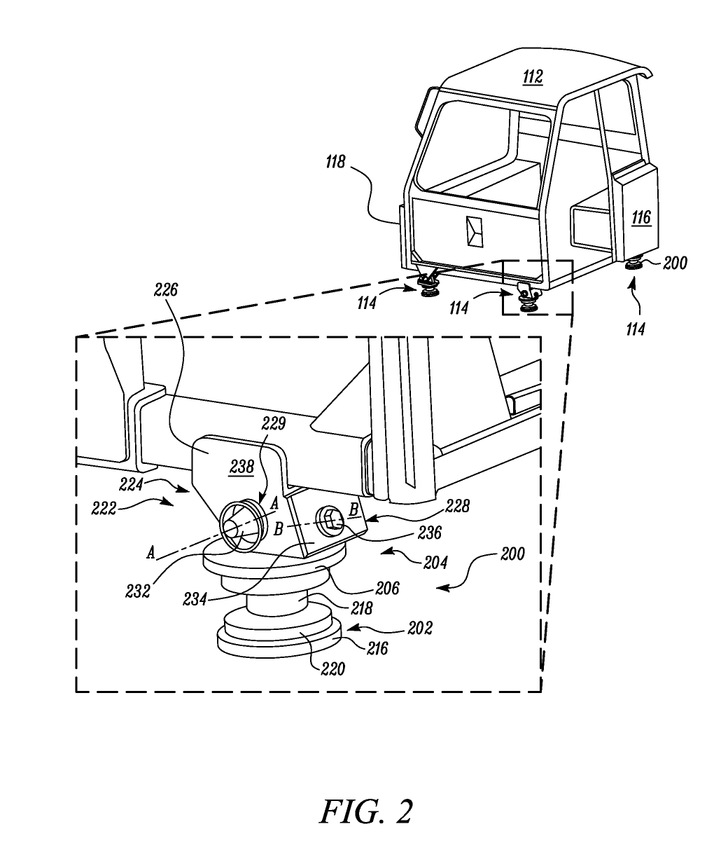

FIG. 2 is a perspective view of the exemplary cab 112 for the machine 100, according to one embodiment of the present disclosure. The cab 112 may be pivotally mounted to the frame 102, such that the cab 112 may tilt in order to access the engine for maintenance. The cab 112 may tilt forward, rearward, and/or sideward with respect to the frame 102 of the machine 100. A number of mounting structures 114 may be provided in association with the cab 112 and the frame 102, in order to allow the cab 112 to tilt with respect to the frame 102 of the machine 100. For example, as illustrated in FIG. 2, four mounting structures 114 may be provided at four different corners of the cab 112. Three out of these four mounting structures 114 are visible in FIG. 2. The design and construction of the mounting structures 114 may vary based on the application. In one embodiment, a mounting system 200 present on one side 116 of the cab 112, may be different in construction and functionality from that present on an opposite side 118 of the cab 112. Various embodiments of the mounting system 200 and its elements will now be explained in detail.

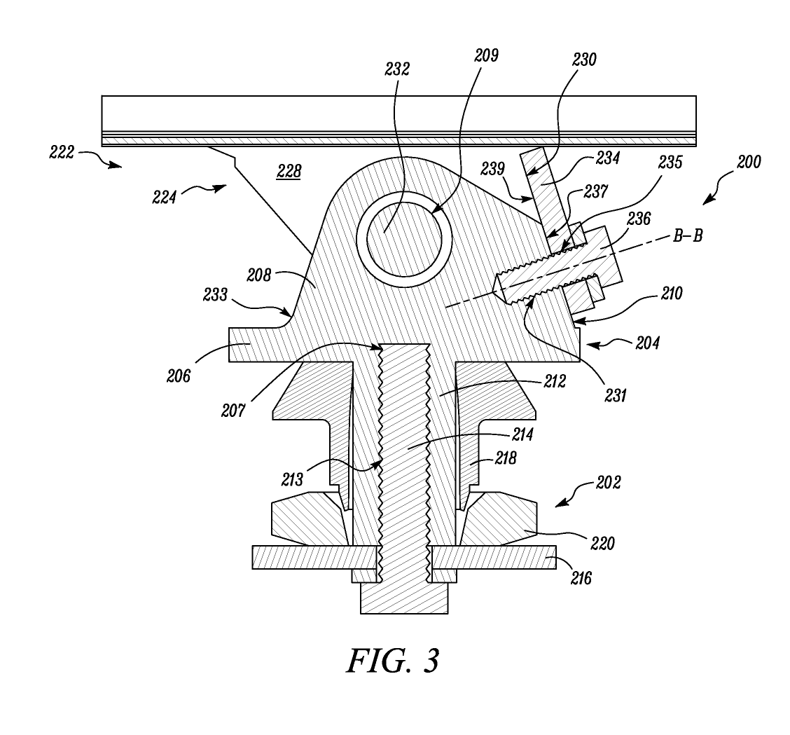

Referring to FIGS. 2 and 3, the mounting system 200 includes a frame mount 202. The frame mount 202 is coupled to the frame 102 of the machine 100. The frame mount 202 includes a mounting head 204. Further, the mounting head 204 includes a base structure 206 and a protruding head member 208. The base structure 206 may embody a disc and may include an opening 207 (see FIG. 3) therein. The protruding head member 208 extends in an upright direction, and in one example, vertically upwards, from an upper surface of the base structure 206. The protruding head member 208 can include an angled surface 210. The angled surface 210 of the protruding head member 208 may be disposed along a frontward facing and/or a rearward facing surface 233, 237 (see FIG. 3) of the mounting head 204. The angled surface 210 is positioned to be obliquely relative to the base structure 206 that extends generally horizontally with a bottom of the cab 112. The protruding head member 208 includes an opening 209 (see FIG. 3) provided therein.

A shaft 212 (see FIG. 3) can be coupled to a lower surface of the base structure 206 in a manner to extend downwardly from the lower surface. The shaft 212 may be embodied as a cylindrical rod provided with a bore 213 provided therein. One end of the shaft 212 is attachable to the lower surface of the base structure 206, whereas another end is attachable to the frame 102 of the machine 100. The bore 213 of the shaft 212 and the opening 207 of the base structure 206 may receive a fastener 214, and in one example, may be threaded to this end, the fastener 214 is configured to threadably couple the frame 102 (shown in FIG. 1) to the base structure 206. The fastener 214 may be a bolt, screw, pin, or a rivet.

The frame mount 202 can include an abutment portion 216. The abutment portion 216 can be positioned to surround the shaft 212 of the frame mount 202. The abutment portion 216 may embody a disc. Further, an isolation member 218 can be disposed between the base structure 206 and the abutment portion 216, such that the isolation member 218 is positioned to surround the shaft 212. The isolation member 218 is configured to dampen noise and vibrations traveling between the cab 112 and the frame 102. In one example, the isolation member 218 may be made of, e.g., rubber, or other elastomer materials. Further, a washer 220 may be provided between the isolation member 218 and the abutment portion 216. The washer 220 may be made of a metallic material such as, e.g., steel.

As illustrated in FIGS. 2 and 3, the mounting system 200 also includes a cab mount 222. The cab mount 222 is configured to be coupled to the cab 112 of the machine 100. The cab mount 222 can include a bracket 224. The bracket 224 is positioned to extend downwardly from a bottom portion of the cab 112. In one example, the bracket 224 can include a pair of upright members, namely a first upright member 226 and a second upright member 228. Further, the first and second upright members 226, 228 is configured to include an angled surface 230 extending obliquely relative to the bottom of the cab 112. The angled surface 230 is shown attached to the rearward facing surface 237 of the mounting head 204.

Each of the first and second upright members 226, 228 include an opening 229 (see FIG. 2) provided therein extending in a lateral direction. The openings 229, 209 provided within the upright members 226, 228 and the protruding head member 208 can be aligned such that a pin 232 may be received therewithin. The pin 232 is configured to couple the cab mount 222 and the frame mount 202. When the frame mount 202 and the cab mount 222 are coupled to one another, the angled surfaces 210, 230 of the protruding head member 208 and the upright members 226, 228, respectively, are coplanar with each other. The pin 232 defines a pin axis A-A, and is configured to pivotally couple the cab mount 222 with the frame mount 202. During a maintenance schedule of the machine 100, the first and second upright members 226, 228 of the cab mount 222 are configured to pivot in unison about the pin 232, thereby allowing the cab 112 to be tilted about the pin 232.

The cab 112 may need to be tilted order to access the engine or other components of the machine 100 that are provided below the cab 112. However, it is not desirable for the cab 112 to pivot or tilt during the operation of the machine 100. The tilting of the cab 112 during operation may create an uncomfortable environment for the machine operator. The present disclosure relates to providing a restriction mechanism that may lock the cab 112 with respect to the frame 102, thereby further inhibiting the movement of the cab 112 during operation of the machine 100 after the servicing and maintenance operations.

As shown in FIGS. 2 and 3, the mounting system 200 may include an angled portion 234 associated therewith. The angled portion 234 is configured to be coupled with the angled surfaces 210, 230 of the protruding head member 208 and the upright members 226, 228, respectively. The angled portion 234 may embody a plate. Further, in one embodiment, a length of the angled portion 234 is less than a length of the angled surface 230 of the upright members 226, 228. In this embodiment, when coupled with the angled surfaces 210, 230, the angled portion 234 of the mounting system 200 is configured to contact the bottom of the cab 112. As shown in the accompanying figures, the angled portion 234 extends obliquely relative to the bottom of the cab 112. When the frame mount 202 and the cab mount 222 are coupled to one another, a frontward facing surface 239 of the angled portion 234 and the angled surface 210 of the protruding head member 208 are positioned in a confronting relationship in contact engagement such to be coplanar with each other. In one embodiment, the angled portion 234 may be integrated with either the angled surface 230 of the upright members 226, 228 or with the angled surface 210 of the protruding head member 208. Alternatively, the angled portion 234 may be cast as a unitary component. In one embodiment, the angled portion 234 and the upright members 226, 228 are integrated to form a single unit.

The angled portion 234 of the mounting system 200 may have an opening 235 (see FIG. 3) formed therein. Further, the angled surface 210 of the protruding head member 208 may also have an opening 231 (see FIG. 3) formed therein, and in one example a threaded bore, such that the openings 231, 235 are aligned when the frame mount 202 and the cab mount 222 are coupled to one another, so as to receive a restriction element 236 therewithin. In one embodiment, the restriction element 236 is configured to releasably couple the angled portion 234 with the angled surfaces 230, 210 of the upright members 226, 228 and the protruding head member 208 respectively. In one example, the restriction element 236 and the opening 231 of the angled surface 210 of the protruding head member 208 may be in threaded engagement. The restriction element 236 may include any of a bolt, rivet, screw, pin, and the like. Further, the angled portion 234 may include a sleeve or a washer provided between the restriction element 236 and the angled portion 234.

It should be noted that, the pin 232 is received by the surface 238 of the first upright member 226, whereas the restriction element 236 is received by the angled surface 210 of the protruding head member 208. Accordingly, the pin 232 and the restriction element 236 are coupled to adjacent surfaces 238, 210 of each of the bracket 224 and the protruding head member 208 respectively. Further, an element axis B-B of the restriction element 236 is shown in FIG. 3 extending generally along the front and rear directions is oblique to the pin axis A-A, shown extending in spaced relationship from the axis A-A such that the axis B-B may extend above or below the axis A-A (as shown in FIG. 2). In another example, the axis B-B is also oblique to the general axis of the shaft 212. During machine operation, the angled portion 234 and the restriction element 236 together lock a pivoting movement of the cab mount 222 with respect to the frame mount 202, thereby inhibiting the movement of the cab 112 during machine operation. The restriction element 236 is positioned with respect to the pin 232 and the shaft 212 in such a manner that the restriction element 236 may exert a force on the shaft 212 in order to inhibit the movement of the cab 112 about the pin 232. Further, during maintenance, the restriction element 236 may be disengaged and the angled portion 234 may be detached from the angled surfaces 210, 230, so that the cab 112 may tilt about the pin 232.

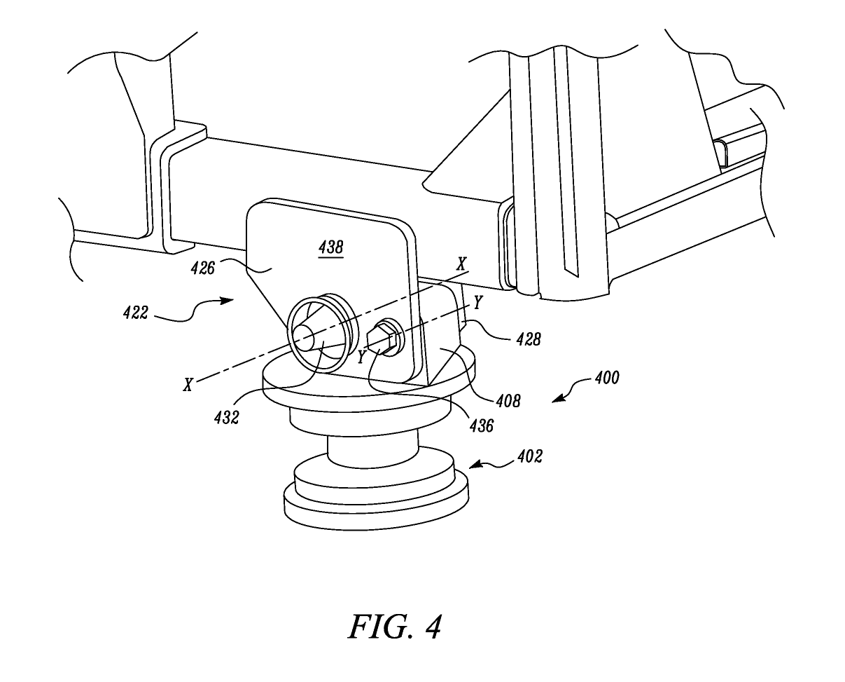

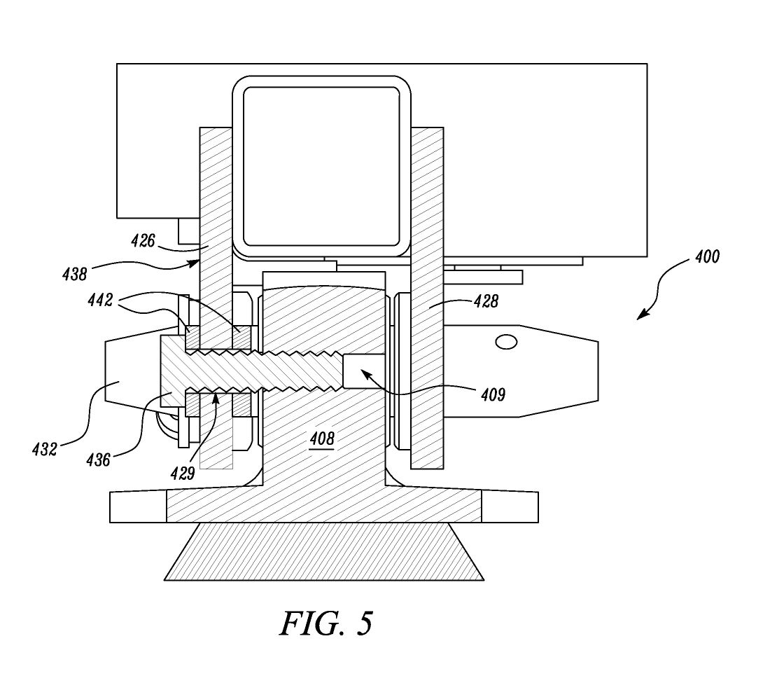

Referring to FIGS. 4 and 5, another embodiment of the mounting system 400 is illustrated. As compared to the embodiment illustrated in FIGS. 2 and 3, in the given embodiment, the first and second upright members 426, 428 of the cab mount 422 and the protruding head member 408 of the frame mount 402 do not have the angled surfaces. Further, the restriction element 436 is threadably coupled to the first upright member 426 and the protruding head member 408, such that the axis Y-Y of the restriction element 436 is parallel to the pin axis X-X. The pin 432 and the restriction element 436 are received on the same surface 438 of the first upright member 426. As shown in the accompanying figures, the restriction element 436 is received within openings 429, 409 (see FIG. 5) provided in each of the first upright member 426 and the protruding head member 408.

Referring to FIG. 5, the first upright member 426 includes a sleeve 442. The sleeve 442 may extend on both sides of the first upright member 426. The sleeve 442 provides an increased contact surface area for the restriction element 436, thereby holding or retaining the restriction element 436 within the mounting system 400. Also, the sleeve 442 is positioned such that the sleeve 442 may reduce a gap existing between the first upright member 426 and the protruding head member 408, thereby restricting the movement of the cab 112 about the pin 432. The sleeve 442 extends through the opening 429 of the first upright member 426 in a coaxial relationship, such that the restriction element 436 is received within the sleeve 442 when installed. Alternatively, the sleeve 442 and the first upright member 426 may be cast as a single unit. Remaining elements of the mounting system 400 are similar to that explained with reference to the mounting system 200 of FIGS. 2 and 3. In another embodiment, it should be noted that the sleeve 442 may be applied around the restriction element 236 shown in FIG. 3 in a similar manner as shown in FIG. 5.

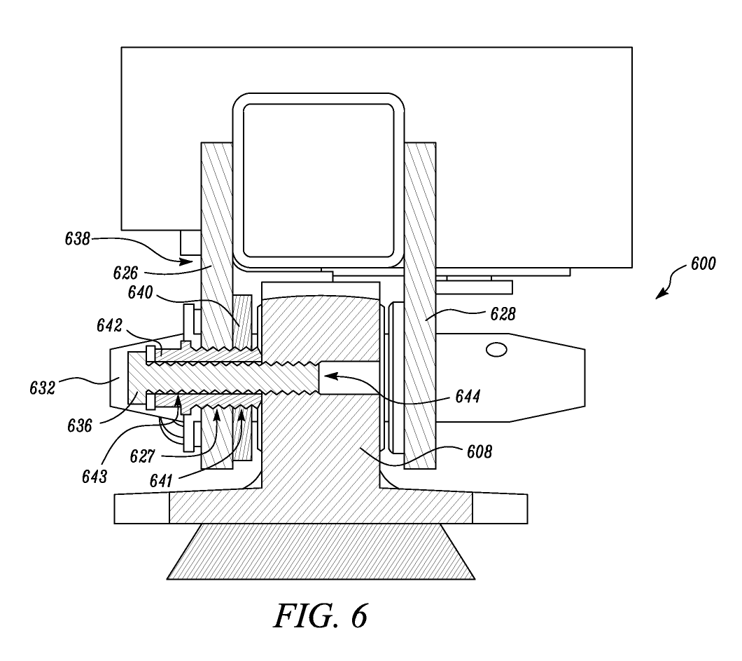

FIG. 6 illustrates a cross sectional view of the mounting system 600, according to various embodiments of the present disclosure. A support member 640 is provided in contact with the inner surface of the first upright member 626. In one example, the support member 640 may be provided as an individual component and thereafter affixed to the first upright member 626. Alternatively, the support member 640 and the first upright member 626 may form a unitary component. The support member 640 includes an opening 641 therein. The opening 641 of the support member 640 is coaxial with the opening 627 of the first upright member 626. Further, the openings 641, 627 of the support member 640 and the first upright member 626 may have equal diameters.

A bushing 642 is threadably provided within the openings 627 of the first upright member 626 and the support member 640. Further, an inner diameter of an opening 643 of the bushing 642 may be approximately equal to a diameter of the opening 644 provided in the protruding head member 608. The openings 643 of the bushing 642 and the opening 644 of the protruding head member 608 may threadably receive the restriction element 636 therewithin. The restriction element 636 may lock or affix the first upright member 626 with the protruding head member 608, thereby restricting, reducing or eliminating the movement of the cab 112 about the pin 632. The restriction element 636 may be removed when the cab 112 is required to be tilted for maintenance purposes. In the embodiments shown in FIGS. 4 to 6, the restriction element 436, 636 couples the first upright member 426, 626 with the protruding head member 408, 608, in order to restrict, reduce or eliminate the movement of the cab 112 about the pin 432, 632. In another embodiment, it should be noted that the bushing 642 and/or the support member 640 may be applied around the restriction element 236 shown in FIG. 3 in a similar manner as shown in FIG. 6.

It should also be noted that the cab mount 222, 422, 622 and the frame mount 202, 402, 602 may be decoupled when the pin 232, 432, 632 and the restriction element 236, 436, 636 are removed. The mounting system 200, 400, 600 is provided on the one side 116 of the cab 112 that can be accessed by the maintenance and service personnel, such that on the removal of the pins 232, 432, 632 and the restriction elements 236, 436, 636 the cab mount 222, 422, 622 and the frame mount 202, 402, 602 of the mounting system 200, 400, 600 is decoupled. The decoupling allows the cab 112 to tilt along the mounting structures 114 present on the opposite side 118 of the cab 112. In one example, the mounting structures 114 present on the opposite side 118 of the cab 112 may not include the restriction element design and functionality. On the one side 116 of the cab 112, the decoupling of the cab mount 222, 422, 622 and the frame mount 202, 402, 602 allows for the cab 112 to be tilted away from the frame mount 202, 402, 602, thereby providing a better access to the components of the machine 100 present underneath the cab 112. After the servicing and maintenance operations, the cab 112 may be restored to a non-tilt position, and the pin 232, 432, 632 and the restriction element 236, 436, 636 can be attached.

### INDUSTRIAL APPLICABILITY

Machines, for example, the articulated truck, include the operator cab. The cab may need to be tilted during maintenance, so that maintenance personnel can access components present below the cab. The mounting structures allow the cab to pivot about a pivot connection. However, these mounting structures do not include any facility for controlling, minimizing or preventing fore/aft movements of the cab during machine operation. This movement of the cab during operation of the machine on irregular terrains may affect a ride experience of the operator and an operator perception from the cab.

The mounting system 200, 400, 600 of the present disclosure includes the bracket 224 having the first upright member 226, 426, 626 and the second upright members 228, 428, 628 respectively. The mounting system 200, 400, 600 also includes the protruding head member 208, 408, 608. The first upright member 226, 426, 626 and the second upright members 228, 428, 628 are pivotally connected to the protruding head member 208, 408, 608 by the pin 232, 432, 632.

In one embodiment, shown in FIGS. 2 and 3, the first and second upright members 226, 228 have the angled surfaces 230. Further, the protruding head member 208 also includes the angled surface 210. The angled surfaces 210, 230 of the protruding head member 208 and the upright members 226, 228 receive the angled portion 234 thereon. The restriction element 236 is coupled to the angled portion 234 and the protruding head member 208 in order to reduce or prevent the movement of the cab 112 about the pin 232. In other embodiments, shown in FIGS. 4-6, the restriction element 436, 636 directly engages the first upright member 426, 626 with the protrusion head member 408, 608 in order to hold the cab 112 in place with respect to the frame 102 of the machine 100.

The mounting system 200, 400, 600 described herein provides improved machine operating conditions, including, but not limited to, an improved ride and operator perception may be achieved. The mounting system 200, 400, 600 allows for flexibility in tilting of the cab 112 when the restriction element 236, 436, 636 are disengaged, and also allows for the cab 112 to be locked with respect to the frame 102 when the restriction element 236, 436, 636 is installed. The mounting system 200, 400, 600 of the present disclosure has a simple design and may be easily incorporated into current cab designs. The restriction elements 236, 436, 636 is provided on the one side 116 of the cab 112, more specifically on that side of the machine 100 which faces an outside environment, so that the personnel may easily install or remove the restriction elements 236, 436, 636, based on the requirement. However, the mounting system 200, 400, 600 design disclosed herein may be modified so as to include the restriction elements 236, 436, 636 on the first upright member 226, 426, 626 as well as the second upright member 228, 428, 628, without deviating from the scope of the present disclosure.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A cab frame mounting system comprising:
a cab mount to couple to a cab;
a frame mount to couple to a frame; and
a pin to couple the cab mount and the frame mount, defining a pin axis,
wherein the cab mount includes a bracket to be extended from a cab bottom, the bracket having an upright member with an opening formed therein to receive the pin and an angled portion coupled to the upright member,
wherein the frame mount includes a mounting head including a base structure; and a protruding head member extending from the base structure, the protruding head member including an opening formed therein to receive the pin,
wherein each of the upright member and the protruding head member include angled surfaces that are in coplanar relationship to engage the angled portion of the bracket when the cab and frame mounts are coupled to one another, the angled surfaces extending obliquely relative to the cab bottom, and
wherein the angled portion and the mounting head each has an opening formed therein to receive a restriction element.

2. The cab frame mounting system of claim 1, wherein the upright member and the angled portion are integrally formed in a single piece.

3. The cab frame mounting system of claim 1, wherein the protruding head member and the angled portion are a single piece.

4. The cab mounting frame mounting system of claim 1, wherein the angled portion contacts the cab bottom.

5. The cab frame mounting system of claim 1, wherein the angled portion is coupled to the angled surfaces of the upright member and the protruding head member respectively.

6. The cab frame mounting system of claim 1, wherein a length of the angled portion is less than a length of the angled surface of the upright member.

7. The cab frame mounting system of claim 1, wherein the pin and the restriction element are coupled to adjacent surfaces of each of the bracket and the protruding head member, the restriction element defining an element axis that extends in spaced relationship from the pin axis.

8. A cab frame mounting system comprising:
a cab mount to couple to a cab;
a frame mount to couple to a frame;
a pin to couple the cab mount and the frame mount, defining a pin axis; and
an angle portion,
wherein the cab mount includes a bracket to be extended from a cab bottom, the bracket having an upright member with an opening formed therein to receive the pin,
wherein the frame mount includes a mounting head including a base structure; and a protruding head member extending from the base structure, the protruding head member including an opening formed therein to receive the pin
wherein the bracket and the mounting head each has an opening formed therein to receive a restriction element defining an element axis, wherein the element axis extends in spaced relationship from the pin axis,
wherein each of the upright member and the protruding head member includes angled surfaces that are in coplanar relationship extending obliquely relative to the cab bottom, and
wherein the angled portion is coupled to the angled surfaces of each of the upright member and the protruding head member.

9. (canceled)

10. (canceled)

11. The cab frame mounting system of claim 8, wherein the angled portion has an opening formed therein to receive the restriction element.

12. The cab frame mounting system of claim 11, wherein the pin and the restriction element are coupled to adjacent surfaces of each of the bracket and the protruding head member.

13. The cab frame mounting system of claim 8 further comprising a sleeve extending through the openings about the restriction element in a coaxial relationship.

14. The cab frame mounting system of claim 13, wherein the sleeve and the upright member of the bracket are a single piece.

15. The cab frame mounting system of claim 13, wherein the sleeve includes a threaded bushing.

16. The cab frame mounting system of claim 13, wherein the pin and the restriction element are coupled to the same surface of each of the bracket and the protruding head member.

17. The cab frame mounting system of claim 13 further comprising:
a support member in contact with an inner surface of the upright member, the support member having an opening formed therein having a coaxial relationship with each of the openings about the restriction element and the sleeve.

18. The cab frame mounting system of claim 8, wherein the restriction element includes a threaded bolt.

19. A machine comprising:
a frame;
a cab; and
a cab frame mounting system to releasably couple the cab to the frame, the cab frame mounting system comprising a cab mount coupled to a cab; a frame mount coupled to a frame; and a pin to couple the cab mount and the frame mount, defining a pin axis,
wherein the cab mount includes a bracket extending from a cab bottom, the bracket having an upright member with an opening formed therein to receive the pin and an angled portion coupled to the upright member,
wherein the frame mount includes a mounting head including a base structure; and a protruding head member extending from the base structure, the protruding head member including an opening formed therein to receive the pin,
wherein each of the upright member and the protruding head member include angled surfaces that are in coplanar relationship to engage the angled portion of the bracket when the cab and frame mounts are coupled to one another, the angled surfaces extending obliquely relative to the cab bottom, and
wherein the angled portion and the mounting head each has an opening formed therein to receive a restriction element.

20. The machine of claim 19, wherein the pin and the restriction element are coupled to adjacent surfaces of each of the bracket and the protruding head member.
